(19) United States
(12) Patent Application Publication
(10) Pub. No.: US 2005/0047140 A1
(43) Pub. Date: Mar. 3, 2005

(54) Lighting device composed of a thin light emitting diode module

(76) Inventor: Jung-Chien Chang, Taoyuan Hsien (TW)

Correspondence Address: VENABLE, BAETJER, HOWARD AND CIVILETTI, LLP, P.O. BOX 34385, WASHINGTON, DC, 20043-9998, US

(21) Appl. No.: 10/646,765

(22) Filed: Aug. 25, 2003

(51) Int. Cl. F21V 29/00

(52) U.S. Cl. 362/267; 362/294; 362/373; 362/800

(57) ABSTRACT

A lighting device composed of a thin LED module has an LED module, a heat sink and a thermally conductive layer clamped between the LED module and the heat sink. The LED module is composed of multiple LED chips densely arranged on a conductive layer in an array without any substrate. By removing the substrate, the lighting device is thin. Additionally, the heat sink is composed of a sealed chamber, vaporable liquid inside the chamber and multiple fins attached to the chamber. Since vaporable liquid transfers heat rapidly and evenly in a gaseous state and the fins increase outside surface areas of the heat sink, the heat sink operates more efficiently, and the lighting device is not easily damaged from accumulated heat.

### BACKGROUND OF THE INVENTION

1. Field of the Invention

The present invention relates to a lighting device, and more particularly to a lighting device composed of a thin light emitting diode module, which dissipates heat quickly, consumes very little energy and is very bright.

2. Description of Related Art

Lighting devices were designed originally to simply create light sources. However, consumers are equally concerned now with the appearance, useful life and energy consumption of lighting devices. Therefore, current lighting devices are available that save energy and meet miniaturization requirements.

For example, light emitting diodes (LED) have replaced early conventional tungsten and halogen bulbs in lighting devices and are used in devices such as traffic lights. Using LEDs as lighting sources has the advantages of consuming less energy consumption to save on operations cost and a longer operational life than tungsten and halogen bulbs to reduce repair and maintenance costs. Therefore, LEDs are preferred for lighting devices. Although the LEDs consume less energy, heat generated by a cluster of LEDs is not an insignificant problem in lighting devices.

With reference to FIG. 6, a conventional LED-based lightening device is composed of an LED module with a cluster or array of LED units. To simplify the description, a single LED unit will be described for illustrative purposes. Each LED unit is composed of a metal substrate (100), an isolating layer (101), a circuit layer (102), an electrically conductive pad (103), a thermally conductive pad (104), an LED chip (110).

The metal substrate (100) has a flat top face (not numbered), and the top face is covered by the isolating layer (101). The circuit layer (102) is mounted on the isolating layer (102). A recess (not numbered) is defined in the isolating layer (101) and the circuit layer (102) to expose the metal substrate (100). The thermally conductive pad (104) is mounted on the metal substrate (100) inside the recess, and the electrically conductive pad (103) is mounted on the thermally conductive pad (104). The LED chip (110) is mounted on the electrically conductive pad (103) and connected to the circuit layer (102) by bonding wires. Additionally, a clear or colored encapsulant covers each LED unit.

In this conventional LED lighting device, the LED chip (110) generates light and heat when the circuit layer (102) is connected to a source of electricity. The heat passes through the electrically conductive pad (103) and the thermally conductive pad (104) into the metal substrate (100) and dissipated from exposed surfaces of the metal substrate (100).

However, conventional LED lighting devices have a drawback in that the lighting device is thick since the lighting device is composed of the metal substrate (100), the thermally conductive pad (104), the electrically conductive pad (103), and selectively the encapsulant formed around the chip (110). The metal substrate (100) is very thick and constitutes a design limit especially when the lighting device needs to be miniaturized. Additionally, the generated heat has to be conducted through a distance (i.e. the thickness) including the substrate (100) and the pads (103, 104), which is slowly dissipated from the surface of the metal substrate (100) and causes overheating to damage other internal elements inside the lighting device.

The present invention provides a breakthrough in LED lighting devices by using a very thin LED module to overcome the drawbacks of the conventional LED lighting devices.

### SUMMARY OF THE INVENTION

A first objective of the present invention is to provide an LED lighting device composed of a thin LED module, wherein the lighting device has a diminished size.

A second objective of the present invention is to provide an LED lighting device that readily dissipates heat and has a long life.

Further benefits and advantages of the present invention will become apparent after a careful reading of the detailed description in accordance with the drawings.

### BRIEF DESCRIPTION OF THE DRAWINGS

FIG. 1 is an exploded operational side plane view of the lighting device composed of a thin LED module in accordance with the present invention, wherein the lighting device further is attached to a heat sink;

FIGS. 2A-2C are sequential cross sectional side plan views of the thin LED module in accordance with the present invention at various stages of fabrication;

FIGS. 3A-3B are sequential cross sectional side plan views of another embodiment of the thin LED module having a flat surface in accordance with the present invention at various stages of fabrication;

FIG. 4 is a top plan view of the thin LED module in accordance with the present invention;

FIG. 5 is a side plane view in partial section of the heat sink in FIG. 1; and

FIG. 6 is a cross-sectional side plan view of a conventional LED lighting device in accordance with the prior art.

### DETAILED DESCRIPTION OF THE PREFERRED EMBODIMENT

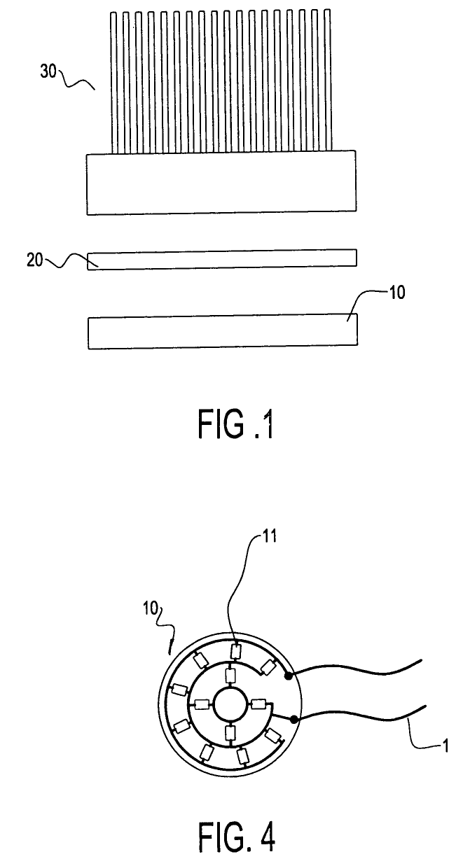

With reference to FIGS. 1 and 4, the lighting device composed of a thin LED module in accordance with the present invention comprises an LED module (10), a thermally conductive sheet (20) and a heat sink (30).

The LED module (10) has a top face (not numbered) and a bottom face (not numbered). The bottom face is electrically connected to conductive wires (1) and light is emitted from the top face.

The thermally conductive layer (20) has a flat top side and a flat bottom side, and the top side is attached to the bottom face of the LED module and also covers the conductive wires (1) on the bottom face of the LED module (10). The thermally conductive layer (20) does not conduct electricity and is selectively made of room temperature vulcanization (RTV) silicon or RTV silicon containing ceramic powder to increase the thermal conductivity of the thermally conductive layer (20). Additionally, the thermally conductive layer (20) is clamped between the LED module (10) and the heat sink (30) by compressing or thermosetting combinations.

The heat sink (30) is attached to the bottom side of the thermally conductive layer (20).

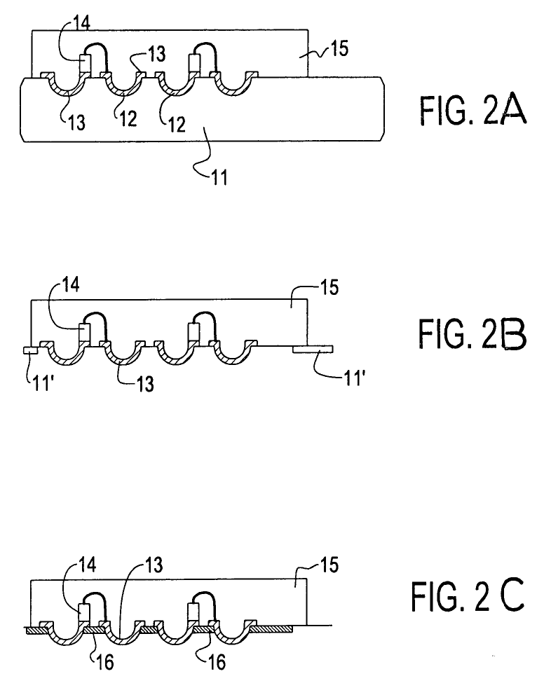

With reference to FIGS. 2A-2C, to facilitate the description of the thin LED module, a method used to fabricate the thin LED module is described. The thin LED module (20) is fabricated by obtaining a substrate (11), forming dimples (12) on the substrate (11), forming a conductive layer (13) on the substrate (11), mounting LED chips (14) on the conductive layer (13), coating the LED chips (14) with an encapsulant layer (15), removing the substrate (11) and optionally applying an isolating layer (16).

The substrate (11) is made of copper, has a top face and a bottom face and serves as a supporting plate during the fabrication process.

The dimples (12) are formed on the top face of the substrate (11) by etching.

The conductive layer (13) has a top face (not numbered) and a bottom face (not numbered), is formed in multiple sections (not numbered) on the top face of the substrate (11) including the dimples (12) and is anticorrosive metal suitable for lead-tin soldering. Furthermore, gold or aluminum wires can be bonded to the conductive layer (13). The conductive layer (13) is composed optionally of copper/nickel/copper/pure nickel/pure gold, pure nickel/pure gold, pure nickel/gold/palladium, etc. Moreover, the thickness of the conductive layer (13) is preferred to be 3 μm to accommodate current desired in the circuit.

LED chips (14) are mounted on the conductive layer (13) to electrically connect adjacent sections of the conductive layer (13). Each LED chip (14) is mounted on one section by silver paste, and a wire connects the LED chip (14) to an adjacent section on the conductive layer (13).

The encapsulant layer (15) is applied with a conventional packaging process to protect the LED chips (14) and is made of transparent material. Since conventional packaging processes are well-know, further description of appropriate packaging processes is omitted.

The substrate (11) is removed by etching from the bottom face of the conductive layer (13). With the substrate (11) removed, the conductive layer (13) at the dimples (12) protrude and can connect to wires. Optionally, parts of the substrate (11) are retained and serve as a lead-frame (11′) at opposite edges of individual LED modules for testing or for bending to be gull-wing leads. Then, the isolating layer (16) is formed on the bottom face of the conductive layer (13) between adjacent protruding dimples (12) and covers exposed sections of the encapsulant layer (15). The insolating layer (16) is white and reflects light emitted from the LED chips (14).

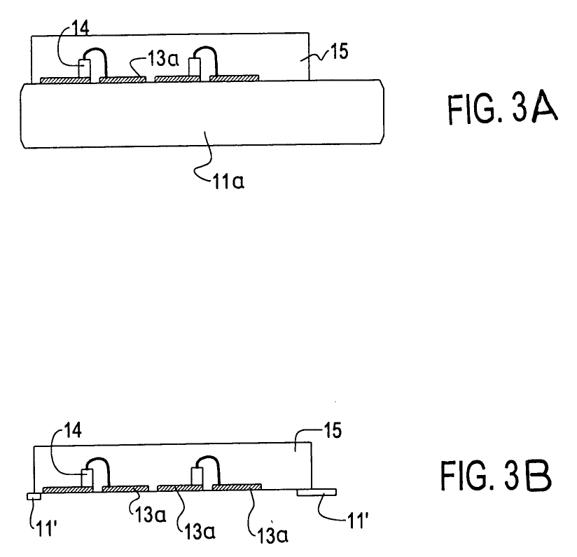

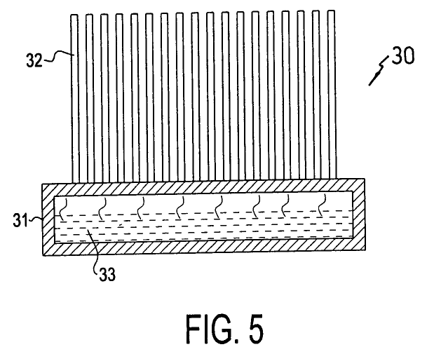

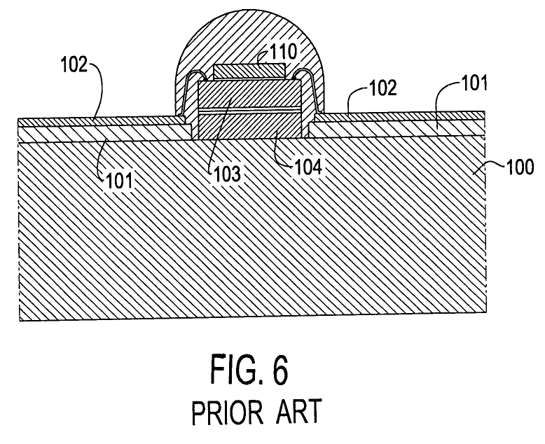

With reference to FIGS. 3A and 3B, another embodiment of the thin LED module is essentially the same as that previously described except no dimples are formed in the substrate (11a) or the conductive layer (13a).

Removing the substrate (11, 11a) causes the thin LED module to be much thinner than the conventional LED module. Therefore, the LED module having no substrate is diminished in thickness but also has multiple LEDs chips (14) densely arranged in an array.

With reference to FIG. 5, the heat sink is also improved in the present invention. The heat sink (30) has an outer surface area (not numbered) and comprises a sealed chamber (31), a vaporable liquid (33) and multiple fins (32). The sealed chamber (31) has an inner face (not numbered), an outer face (not numbered) and an inside surface (not numbered). The inner face of the heat sink (30) attaches to the thermally conductive layer (20) to absorb heat from the thin LED module. The vaporable liquid (33) is held inside the chamber (31) near the inner face to absorb heat from the LED module (10). The fins (32) respectively have a proximal end (not numbered) and a distal end (not numbered). The proximal ends of the fins (32) are attached to the outer face of the chamber (31) so the fins (32) increase the outer surface area of the heat sink (31). The heat sink (30) works by absorbing heat from the LED module (10) through the inner face. The absorbed heat causes the vaporable liquid (33) inside the sealed chamber (31) to vaporize and conduct heat more readily to the outer face of the sealed chamber (31). Then heat in the outer face is conducted heat to the fins (32) and dissipated to the environment. Since the vaporable liquid (33) transfers heat to the outer face of the chamber (31) and the fins (32) in a gaseous state, the heat is evenly transferred to the fins (32) so the heat dissipated from the fins (32) is dissipated at or near peak efficiency. Furthermore, the vaporable liquid (33) condenses quickly when heat is transferred to the outer face and the fins (32).

Several advantages of the lighting device composed of a thin LED module are listed as follow:

1. Since the LED module (10) has no substrate (11), the lighting device is significantly thinner. Thereby, the lighting device can be minimized.

2. The lighting device is stable and durable because the heat sink dissipates generated heat rapidly to avoid malfunctions caused from overheating.

3. The lighting device has excellent brightness since the LED chips (14) can be densely mounted in a thin LED module (10).

Although the invention has been explained in relation to its preferred embodiment, many other possible modifications and variations can be made without departing from the spirit and scope of the invention as hereinafter claimed.

1. A lighting device composed of a thin LED module, the lighting device comprising:
a LED module (10) having a top face and a bottom face, wherein the bottom face is adapted to electrically connect to conductive wires and the top face emits light; the LED module (10) comprising:
a conductive layer (13) with multiple sections;
multiple LED chips (14) mounted respectively between adjacent sections of the conductive layer (13); and
an encapsulant (15) formed on the conductive layer (13) to cover and protect the multiple LED chips (14);
a thermally conductive layer (20) having a flat top side attached to the bottom face of the LED module and a flat bottom side; and
a heat sink (30) having an outer surface area and attached to the bottom side of the thermally conductive layer (20);
when the lighting device operates, heat generated by the LED module (10) is transferred through the thermally conductive layer (20) to the heat sink (30) and efficiently radiated to a low lighting device temperature.

2. The lighting device as claimed in claim 1, wherein the LED chips (14) are densely arranged on the conductive layer (13).

3. The lighting device as claimed in claim 1, wherein the heat sink comprises:
a sealed chamber (31) having an inner face attached to the bottom side of the thermally conductive layer (20), an outer face and an inside surface;
a vaporable liquid (33) held inside the sealed chamber (31) near the inner face to absorb heat from the LED module (10); and
multiple fins (32) attached to the outer face of the sealed chamber (31) to increase outer surface areas of the heat sink (31).

4. The lighting device as claimed in claim 2, wherein the heat sink comprises:
a sealed chamber (31) having an inner face attached to the bottom side of the thermally conductive layer (20), an outer face and an inside surface;
a vaporable liquid (33) held inside the sealed chamber (31) near the inner face to absorb heat from the LED module (10); and
multiple fins (32) attached to the outer face of the sealed chamber (31) to increase outer surface areas of the heat sink (31).

5. The lighting device as claimed in claim 3, wherein the thermally conductive layer (20) is nonconductive in electricity and is made of room temperature vulcanization (RTV) silicon.

6. The lighting device as claimed in claim 4, wherein the thermally conductive layer (20) is nonconductive in electricity and is selectively made of room temperature vulcanization (RTV) silicon.

7. The lighting device as claimed in claim 3, wherein the thermally conductive layer (20) is nonconductive in electricity and is made of room temperature vulcanization silicon further containing ceramic powder.

8. The lighting device as claimed in claim 4, wherein the thermally conductive layer (20) is nonconductive in electricity and is made of room temperature vulcanization silicon further containing ceramic powder.
